(19) United States
(12) Patent Application Publication
(10) Pub. No.: US 2025/0227554 A1
(43) Pub. Date: Jul. 10, 2025

(54) SYSTEMS AND METHODS FOR IMPROVING SPECTRAL EFFICIENCY WITH NETWORK SLICING RRP

(71) Applicant: T-Mobile Innovations LLC, Overland Park, KS (US)

(72) Inventors: Mochamad MIRZA, Bothell, WA (US); Liezel REOGANIS, Redmond, WA (US); Hui-Hsia SUNG, Bellevue, WA (US)

(21) Appl. No.: 18/408,665

(22) Filed: Jan. 10, 2024

(51) Int. Cl. H04W 28/08; H04W 24/02; H04W 24/08

(52) U.S. Cl. CPC H04W 28/0983; H04W 24/02; H04W 24/08

(57) ABSTRACT

Systems and methods are provided for improving spectral efficiency in a wireless network. The methods include determining that one or more reduced capability devices are using a network slice. The methods further include determining that the spectral efficiency of the network slice has dropped below a spectral efficiency threshold. The methods further include reducing a radio resource partitioning ratio of the one or more reduced capability devices to non-reduced capability devices.

### TECHNICAL BACKGROUND

A wireless network, such as a cellular network, can include an access node (e.g., base station) serving multiple wireless devices or user equipment (UE) in a geographical area covered by a radio frequency transmission provided by the access node. Access nodes may deploy different carriers within the cellular network utilizing different radio access technologies (RATs). RATs can include, for example, 3G RATs (e.g., GSM, CDMA etc.), 4G RATs (e.g., WiMax, LTE, etc.), and 5G RATs (new radio (NR)). RATS may additionally include, for example, Wi-Fi and Bluetooth. Additionally, different standards may be implemented, including one or more International Engineering Task Force (IETF) standards; one or more of the Institute of Electrical and Electronics Engineers (IEEE) 802.11 standards; and/or any other industry standards and/or specifications. Further, different types of access nodes may be implemented for deployment for the various RATs. For example, an evolved NodeB (eNodeB or eNB) may be utilized for 4G RATs and a next generation NodeB (gNodeB or gNB) may be utilized for 5G RATs. Deployment of the evolving RATs in a network provides numerous benefits. For example, newer RATs may provide additional resources to subscribers, faster communications speeds, and other advantages. For example, 5G networks provide edge deployments enabling computing capabilities closer to UEs.

Network slicing allows a single network to be divided into multiple slices. Each slice can be configured and used in its own way. For example, a network slice may be established and configured for a Mobile Virtual Network Operator (MVNO) to lease from a larger cellular service provider. As another example, network slices may be configured for different Quality of Service (QOS) levels such as a network slice for video streaming with its high bandwidth requirements and another for voice over IP (VOIP) with its low latency but low bandwidth requirements.

### OVERVIEW

Examples described herein include systems and methods for improving spectral efficiency. An exemplary method includes determining that one or more reduced capability devices are using a network slice. The method further includes determining that the spectral efficiency of the network slice has dropped below a spectral efficiency threshold. The method further includes reducing a radio resource partitioning (RRP) ratio of the one or more reduced capability devices to non-reduced capability devices.

Another exemplary embodiment includes a system including a network slice controller which includes at least one electronic processor configured to perform operations. The operations include determining that one or more reduced capability devices are using a network slice. The operations further include determining that a spectral efficiency of the network slice has dropped below a spectral efficiency threshold. The operations further include reducing a radio resource partitioning (RRP) ratio of the one or more reduced capability devices to non-reduced capability devices.

Another exemplary method includes monitoring a service level of one or more reduced capability devices. The method further includes determining that a spectral efficiency of the network slice has dropped below a spectral efficiency threshold. The method further includes incrementally reducing a radio resource partitioning (RRP) ratio of the one or more reduced capability devices until the service level of the one or more reduced capability devices decreases to a service level threshold.

### BRIEF DESCRIPTION OF THE DRAWINGS

These and other more detailed and specific features of various embodiments are more fully disclosed in the following description, reference being had to the accompanying drawings, in which:

FIG. 1 illustrates an exemplary system for wireless communication in accordance with various aspects of the present disclosure;

FIG. 2 illustrates an exemplary processing node in accordance with various aspects of the present disclosure;

FIG. 3 illustrates an exemplary process flow for improving spectral efficiency in a wireless network; and

FIG. 4 illustrates an exemplary process flow for improving spectral efficiency in a wireless network.

### DETAILED DESCRIPTION

In the following description, numerous details are set forth, such as flowcharts, schematics, and system configurations. It will be readily apparent to one skilled in the art that these specific details are merely exemplary and not intended to limit the scope of this application.

In accordance with various aspects of the present disclosure, a 5G core network provides network slices to allow for many virtualized networks to be provided on the hardware architecture of the cellular network operator. These network slices are shared between many wireless devices, which leads to situations where some wireless devices can impact the network performance of other wireless devices. Using reduced capability (RedCap) devices within a network slice can have adverse effects on the other devices within that same network slice and the overall spectral efficiency of the network slice as a whole. This can happen when so-called reduced capability (RedCap) devices are added to a network slice with regular 5G wireless devices such as modern mobile phones. The non-reduced capability wireless devices may be referred to as enhanced mobile broadband (eMBB) devices.

RedCap devices include things like smart watches and other wearables, industrial sensors, and video surveillance equipment, for example. RedCap devices, as the name implies, have less capabilities than a typical eMBB devices and require less resources from a wireless network to adequately function. They may be characterized by having a maximum bandwidth of 100 MHz or 20 MHz depending on which frequency range they are operating on. For example, 100 MHz is supported on Frequency Range 2 (FR2) and 20 MHz is supported on Frequency Range 1 (FR1). They may also be limited to one or two Rx branches with either one or two MIMO layers being supported, respectively. They also could have a maximum modulation order of 64 QAM rather than the 256 QAM for eMBB devices depending on factors including frequency range. For example, 256 QAM is optionally supported for RedCap devices of FR1 DL, but FR1 UL, and FR2 UL/DL support 64 QAM.

By default, if there are eMBB and RedCap devices operating on the same network slice, the network slice is divided in half with half going to each device type. With the RedCap devices using less bandwidth than the eMBB devices, this usually leads to unused bandwidth in the RedCap half of the slice, thus reducing spectral efficiency. Introducing RedCap 2×2 MIMO to a 5G network has been shown to reduce spectral efficiency by up to 50% on downlink and up to 25% on uplink. Radio Resource Partitioning (RRP) can be used to move away from the 50:50 split and to gain better control of the bandwidth in a network slice. If at least one RedCap device is detected using a network slice and the spectral efficiency starts to fall below a threshold, the RRP ratio of RedCap devices to eMBB devices can be reduced. This has been shown to reduce the negative impact the RedCap device has on spectral efficiency for the network slice. The RRP ratio may be reduced incrementally in increments of different sizes, 5-10% for example. RRP ratio may also be initially reduced to where 5-10% of the network slice is for RedCap devices.

Reducing the RRP ratio too far can lead to performance problems for the RedCap devices. One method of ensuring that the RedCap devices are not impacted too badly is to monitor the service level of the RedCap devices as the RRP ratio is reduced. If the service level of the RedCap devices drops too low, 2-5 Mpbs throughput, for example, the RRP ratio reduction may be stopped, or it may be reversed slightly to ensure a proper QoS for the RedCap devices. A minor reduction in performance is expected, but the Service Level Agreements (SLA) for the RedCap devices should be maintained. Typically, RedCap devices are not very sensitive to minor fluctuations in performance. If there is difficulty in maintaining the SLA and/or the network slice becomes saturated, the RedCap devices may be offloaded to another slice. During contention, RedCap traffic may be offloaded to another carrier if the serving carrier has reached RRP threshold and the target carrier is below RRP threshold.

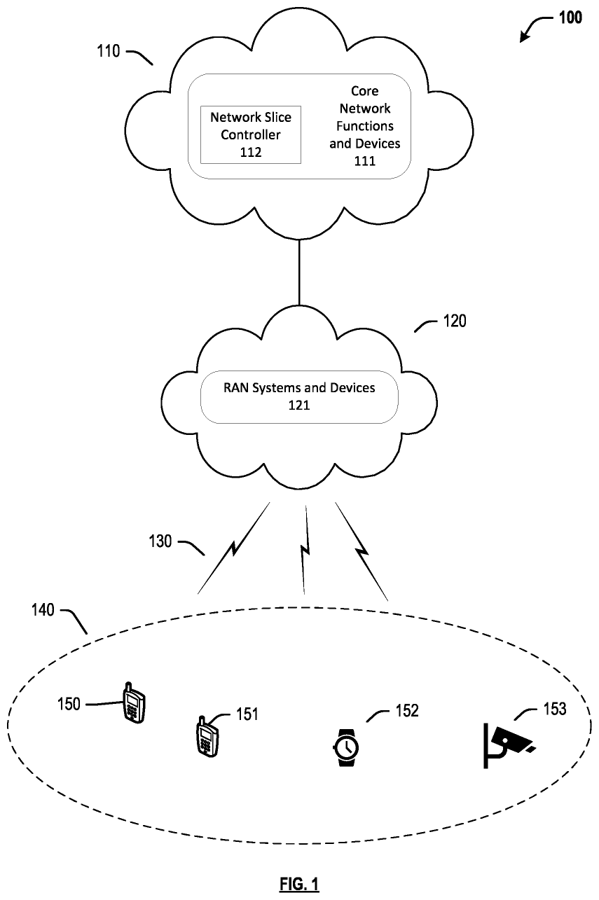

FIG. 1 depicts an exemplary system 100 for wireless communication, in accordance with the disclosed embodiments. The system 100 may include a core network 110, a radio access network (RAN) 120 and multiple wireless devices 150-153 able to communicate within the network. The wireless devices 150-153 may be end-user wireless devices and may operate within one or more coverage areas 140 and communicate with the RAN 120 over communication links 130, which may for example be 5G NR communication links, 4G LTE communication links, or any other suitable type of communication link. The core network 110 includes core network functions and devices 111. The core network may be structured using a service-based architecture (SBA). A network slice controller 112 is one of the core network functions 111. There are many other core network functions and devices 111 that are omitted for clarity.

The RAN 120 may include various RAN systems and devices 121. The RAN systems and devices 121 are disposed between the core network 110 and the end-user wireless devices 150-153. Some of the RAN systems and devices 121 may communicate directly with the core network 110 and others may communicate directly with the end user wireless devices 150-153. Other RAN systems and devices 121 may communicate with one another within the RAN in order to provide services from the core network 110 to the end-user wireless devices 150-153.

The RAN 120 includes at least an access node (or base station), such as an eNodeB, a next generation NodeB (gNodeB) communicating with a plurality of end-user wireless devices. It is understood that the disclosed technology may also be applied to communication between an end-user wireless device and other network resources, such as relay nodes, controller nodes, antennas, etc. Further, multiple access nodes may be utilized. For example, some wireless devices 150-153 may communicate with an LTE eNodeB and others may communicate with an NR gNodeB.

Access nodes can be, for example, standard access nodes such as a macro-cell access node, a base transceiver station, a radio base station, an eNodeB device, an enhanced eNodeB device, a next generation NodeB (or gNodeB) in 5G New Radio (“5G NR”), or the like. In additional embodiments, access nodes may comprise two co-located cells, or antenna/transceiver combinations that are mounted on the same structure. Alternatively, access nodes may comprise a short range, low power, small-cell access node such as a microcell access node, a picocell access node, a femtocell access node, or a home eNodeB device.

Access nodes can be configured to deploy at least two different carriers, each of which utilizes a different RAT. For example, a first carrier may be deployed by an access node in an LTE mode, and a second carrier may be deployed by an access node in an NR mode. Thus, in an embodiment, the access node may comprise two co-located cells, or antenna/transceiver combinations that are mounted on the same structure. In some embodiments, multiple access nodes may be deployed and each access node may support a different RAT. For example, a gNodeB may support NR and an eNodeB may provide LTE coverage. Any other combination of access nodes and carriers deployed therefrom may be evident to those having ordinary skill in the art in light of this disclosure.

The access nodes can comprise a processor and associated circuitry to execute or direct the execution of computer-readable instructions to perform operations such as those further described herein. Access nodes can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

Each of wireless devices 150-153 may be capable of simultaneously communicating with the RAN 120 using combinations of antennae via 4G and 5G or any other RAT or transmission mode, including multiple carriers. For instance, MU-MIMO pairings and SU-MIMO pairings can be made by wireless devices 150-153. It is noted that any number of access nodes, antennae, MU-MIMO pools, carriers, and wireless devices can be implemented.

Wireless devices 150-153 may be any device, system, combination of devices, or other such communication platform capable of communicating on the wireless network using one or more frequency bands deployed therefrom. Wireless devices 150-153 may be divided into two categories for the purposes of this disclosure. Wireless devices 150-151 may be eMBB devices and may be, for example, mobile phones, wireless phones, cellular home internet modems, personal digital assistants (PDA), tablet computers, as well as other types of devices or systems that can exchange audio or data via the wireless network as non-reduced capability devices. Wireless devices 152-153 may be reduced capability (RedCap) devices and may include smart watches and other wearables, industrial sensors, and video surveillance equipment, for example. Other types of communication platforms are possible.

In operation, network slice controller 112 may be configured to execute a method including determining that one or more reduced capability devices 152-153 are using a network slice. The method may further include determining the spectral efficiency of the network slice has dropped below a spectral efficiency threshold. The method may further include reducing a radio resource partitioning (RRP) ratio of the one or more reduced capability devices 152-153 to non-reduced capability devices 150-151. The method may further include monitoring a service level of the one or more reduced capability devices 152-153 and increasing the RRP ratio of the reduced capability devices 152-153 to non-reduced capability devices 150-151 if the service level drops below a service level threshold. The service level threshold may be approximately 2-5 Mbps of throughput. The method may further include monitoring a service level of the reduced capability devices 152-153 and the usage level of the network slice and offloading one or more reduced capability devices 152-153 to a different network slice if the usage level of the network slice is above a saturation threshold and the service level of the reduced capability devices 152-153 is below a service level threshold. The saturation threshold may be determined by a network slice provider and would typically be characterized by a performance degradation due to a high level of data being transmitted on the network slice.

A wireless device 150-153 may be considered a reduced capability device 152-153 if its network requirements are lower than typical eMBB devices 150-151. For example, RedCap devices 152-153 may be characterized by having a maximum bandwidth of 100 MHz or 20 MHz depending on which frequency range they are operating on. For example, 100 MHz is supported on Frequency Range 2 (FR2) and 20 MHz is supported on Frequency Range 1 (FR1). They may also be limited to one or two Rx branches with either one or two MIMO layers being supported, respectively. They also could have a maximum modulation order of 64 QAM rather than the 256 QAM for eMBB devices 150-151 depending on factors including frequency range. For example, 256 QAM is optionally supported for RedCap devices of FR1 DL, but FR1 UL, and FR2 UL/DL support 64 QAM.

System 100 may further include many components not specifically shown in FIG. 1 including processing nodes, controller nodes, routers, gateways, and physical and/or wireless data links for communicating signals among various network elements. System 100 may include one or more of a local area network, a wide area network, and an internetwork (including the Internet). System 100 may be capable of communicating signals and carrying data, for example, to support voice, push-to-talk, broadcast video, and data communications by end-user wireless devices 150-153. Wireless network protocols may include one or more of Multimedia Broadcast Multicast Services (MBMS), code division multiple access (CDMA) 1×RTT (radio transmission technology), Global System for Mobile communications (GSM), Universal Mobile Telecommunications System (UMTS), High-Speed Packet Access (HSPA), Evolution Data Optimized (EV-DO), Worldwide Interoperability for Microwave Access (WiMAX), Third Generation Partnership Project Long Term Evolution (3GPP LTE), Fourth Generation broadband cellular (4G, LTE Advanced, etc.), and Fifth Generation mobile networks or wireless systems (5G, 5G New Radio (“5G NR”), or 5G LTE). Wired network protocols utilized by communication network 101 may include one or more of Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM).

Other network elements may be present in system 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. the core network functions and devices 111 and RAN 120.

Further, the methods, systems, devices, networks, access nodes, and equipment described above may be implemented with, contain, or be executed by one or more computer systems and/or processing nodes. The methods described above may also be stored on a non-transitory computer readable medium. Many of the elements of communication system 100 may be, comprise, or include computers systems and/or processing nodes. This includes, but is not limited to network slice controller 112, other core network functions and devices 111, and RAN systems and devices 121.

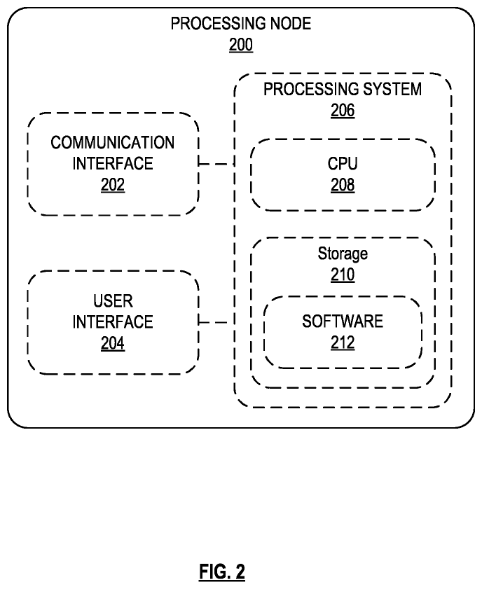

FIG. 2 depicts an exemplary processing node 200, which may be configured to perform the methods and operations disclosed herein to improve spectral efficiency. The processing node 200 includes a communication interface 202, user interface 204, and processing system 206 in communication with communication interface 202 and user interface 204. Processing system 206 includes a processor 208, storage 210, which can comprise a disk drive, flash drive, memory circuitry, or other memory device including, for example, a buffer. Storage 210 can store software 212 which is used in the operation of the processing node 200. Software 212 may include computer programs, firmware, or some other form of machine-readable instructions, including an operating system, utilities, drivers, network interfaces, applications, or some other type of software. Processing system 206 may include a microprocessor 208 and other circuitry to retrieve and execute software 212 from storage 210. Processing node 200 may further include other components such as a power management unit, a control interface unit, etc., which are omitted for clarity. Communication interface 202 permits processing node 200 to communicate with other network elements. User interface 204 permits the configuration and control of the operation of processing node 200.

In an exemplary embodiment, software 212 can include instructions for determining that one or more reduced capability devices are using a network slice. The instructions may further include determining that a spectral efficiency of the network slice has dropped below a spectral efficiency threshold. The instructions may further include reducing a radio resource partitioning (RRP) ratio of the one or more reduced capability devices to non-reduced capability devices. The instructions may further include monitoring a service level of the one or more reduced capability devices and increasing the RRP ratio of the reduced capability devices to non-reduced capability devices if the service level drops below a service level threshold. The service level threshold may be approximately 2-5 Mbps of throughput. The method may further include monitoring a service level of the reduced capability devices and the usage level of the network slice and offloading one or more reduced capability devices to a different network slice if the usage level of the network slice is above a saturation threshold and the service level of the reduced capability devices is below a service level threshold. The saturation threshold may be determined by a network slice provider and would typically be characterized by a performance degradation due to a high level of data being transmitted on the network slice.

A wireless device may be considered a reduced capability device if its network requirements are lower than typical eMBB devices. For example, reduced capability devices may be characterized by having a maximum bandwidth of 100 MHz or 20 MHz depending on which frequency range they are operating on. For example, 100 MHz is supported on Frequency Range 2 (FR2) and 20 MHz is supported on Frequency Range 1 (FR1). They may also be limited to one or two Rx branches with either one or two MIMO layers being supported, respectively. They also could have a maximum modulation order of 64 QAM rather than the 256 QAM for eMBB devices depending on factors including frequency range. For example, 256 QAM is optionally supported for RedCap devices of FR1 DL, but FR1 UL, and FR2 UL/DL support 64 QAM.

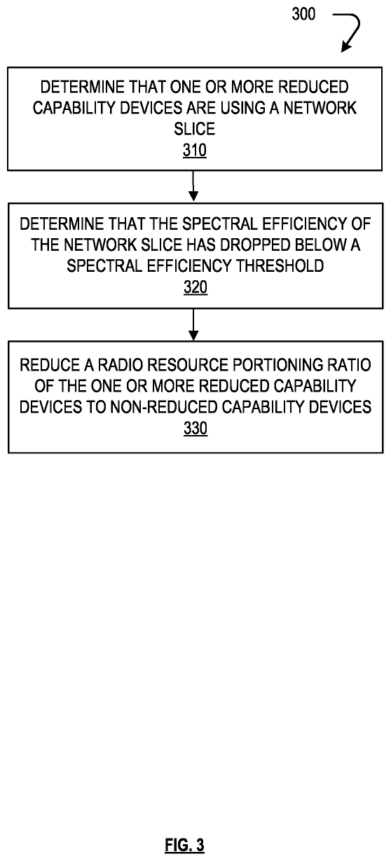

FIG. 3 illustrates an exemplary method 300 for managing spectral efficiency. Method 300 can be implemented by any suitable combination of processors, such as processing node 200. Although FIG. 3 depicts steps performed in a particular order for purposes of illustration and discussion, the operations discussed herein are not limited to any particular order or arrangement. One skilled in the art, using the disclosures provided herein, will appreciate that various steps of the methods can be omitted, rearranged, combined, and/or adapted in various ways.

Method 300 begins in step 310 where it is determined that one or more reduced capability devices are using a network slice. Method 300 continues in step 320 where it is determined that a spectral efficiency of the network slice has dropped below a spectral efficiency threshold. Method 300 continues in step 330 where a radio resource partitioning (RRP) ratio of the one or more reduced capability devices to non-reduced capability devices is reduced.

Method 300 may include the optional steps of monitoring a service level of the one or more reduced capability devices and increasing the RRP ratio of the reduced capability devices to non-reduced capability devices if the service level drops below a service level threshold. The service level threshold may be approximately 2-5 Mbps of throughput. Method 300 may include the optional steps of monitoring a service level of the reduced capability devices and the usage level of the network slice and offloading one or more reduced capability devices to a different network slice if the usage level of the network slice is above a saturation threshold and the service level of the reduced capability devices is below a service level threshold. The saturation threshold may be determined by a network slice provider and would typically be characterized by a performance degradation due to a high level of data being transmitted on the network slice.

A wireless device may be considered a reduced capability device if its network requirements are lower than typical eMBB devices. For example, reduced capability devices may be characterized by having a maximum bandwidth of 100 MHz or 20 MHz depending on which frequency range they are operating on. For example, 100 MHz is supported on Frequency Range 2 (FR2) and 20 MHz is supported on Frequency Range 1 (FR1). They may also be limited to one or two Rx branches with either one or two MIMO layers being supported, respectively. They also could have a maximum modulation order of 64 QAM rather than the 256 QAM for eMBB devices depending on factors including frequency range. For example, 256 QAM is optionally supported for RedCap devices of FR1 DL, but FR1 UL, and FR2 UL/DL support 64 QAM.

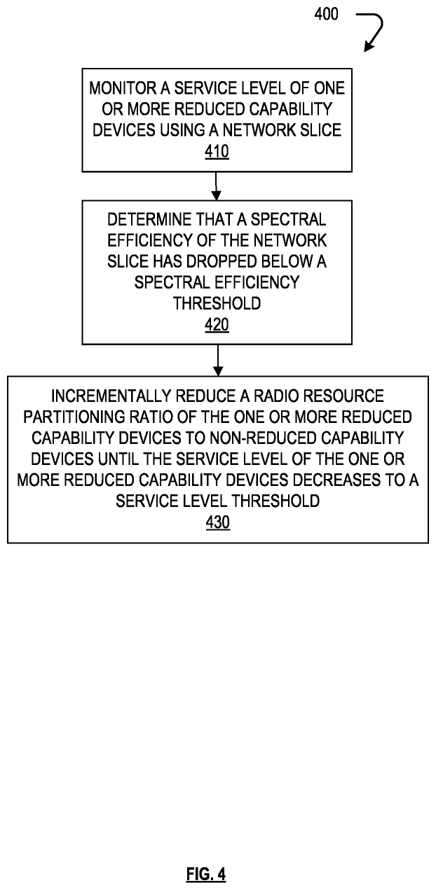

FIG. 4 illustrates an exemplary method 400 for managing spectral efficiency. Method 400 can be implemented by any suitable combination of processors, such as processing node 200. Although FIG. 4 depicts steps performed in a particular order for purposes of illustration and discussion, the operations discussed herein are not limited to any particular order or arrangement. One skilled in the art, using the disclosures provided herein, will appreciate that various steps of the methods can be omitted, rearranged, combined, and/or adapted in various ways.

Method 400 begins in step 410 where a service level of one or more reduced capability devices using a network slice is monitored. Method 400 continues in step 420 where it is determined that a spectral efficiency of the network slice has dropped below a spectral efficiency threshold. Method 400 continues in step 430 where a radio resource partitioning (RRP) ratio of the one or more reduced capability devices to non-reduced capability devices is incrementally reduced until the service level of the one or more reduced capability devices decreases to a service level threshold. The service level threshold may be set to any useable amount including 5 Mbps throughput, for example. The increment at which the RRP ratio is reduced may be set to any useable amount including 5% of the total bandwidth of the network slice, for example.

Method 400 may include the optional steps of monitoring the usage level of the network slice and offloading one or more reduced capability devices to a second network slice if it is determined that the usage level of the network slice is above a saturation threshold and the service level of the one or more reduced capability devices is below the service level threshold. The saturation threshold may be determined by a network slice provider and would typically be characterized by a performance degradation due to a high level of data being transmitted on the network slice.

A wireless device may be considered a reduced capability device if its network requirements are lower than typical eMBB devices. For example, reduced capability devices may be characterized by having a maximum bandwidth of 100 MHz or 20 MHz depending on which frequency range they are operating on. For example, 100 MHz is supported on Frequency Range 2 (FR2) and 20 MHz is supported on Frequency Range 1 (FR1). They may also be limited to one or two Rx branches with either one or two MIMO layers being supported, respectively. They also could have a maximum modulation order of 64 QAM rather than the 256 QAM for eMBB devices depending on factors including frequency range. For example, 256 QAM is optionally supported for RedCap devices of FR1 DL, but FR1 UL, and FR2 UL/DL support 64 QAM.

In some embodiments, methods 300 and 400 may include additional steps or operations. Furthermore, the methods may include steps shown in each of the other methods. As one of ordinary skill in the art would understand, the methods of 300 and 400 may be integrated in any useful manner and the steps may be performed in any useful sequence.

The exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid-state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method of improving spectral efficiency, the method comprising:
determining that one or more reduced capability devices are using a network slice;
determining the spectral efficiency of the network slice has dropped below a spectral efficiency threshold; and
reducing a radio resource partitioning (RRP) ratio of the one or more reduced capability devices to non-reduced capability devices.

2. The method of claim 1 further comprising:
monitoring a service level of the one or more reduced capability devices; and
upon determining that the service level of the one or more reduced capability devices has dropped below a service level threshold, increasing the RRP ratio of the one or more reduced capability devices to non-reduced capability devices.

3. The method of claim 2, wherein the service level threshold is 5 Mbps.

4. The method of claim 1, the method further comprising:
monitoring a service level of the one or more reduced capability devices;
monitoring a usage level of the network slice; and
upon determining that the usage level of the network slice is above a saturation threshold and the service level of the one or more reduced capability devices is below a service level threshold, offloading one or more of the reduced capability devices to a second network slice.

5. The method of claim 1, wherein the one or more reduced capability devices have a downlink limited to a maximum of 2 MIMO layers.

6. The method of claim 1, wherein the one or more reduced capability devices have a maximum bandwidth of 20 MHz.

7. The method of claim 1, wherein the one or more reduced capability devices have a maximum downlink modulation order of 64 QAM.

8. The method of claim 1, wherein the one or more reduced capability devices have a maximum uplink modulation order of 64 QAM.

9. A system, the system comprising:
a network slice controller including at least one electronic processor configured to perform operations, the operations comprising:
determining that one or more reduced capability devices are using a network slice;
determining that a spectral efficiency of the network slice has dropped below a spectral efficiency threshold; and
reducing a radio resource partitioning (RRP) ratio of the one or more reduced capability devices to non-reduced capability devices.

10. The system of claim 9, wherein the operations further comprise:
monitoring a service level of the one or more reduced capability devices; and
upon determining that the service level of the one or more reduced capability devices has dropped below a service level threshold, increasing the RRP ratio of the one or more reduced capability devices to non-reduced capability devices.

11. The system of claim 10, wherein the service level threshold is 5 Mbps.

12. The system of claim 9, wherein the operations further comprise:
monitoring a service level of the one or more reduced capability devices;
monitoring a usage level of the network slice; and
upon determining that the usage level of the network slice is above a saturation threshold and the service level of the one or more reduced capability devices is below a service level threshold, offloading one or more of the reduced capability devices to a second network slice.

13. The system of claim 9, wherein reducing the RRP ratio of the one or more reduced capability devices to non-reduced capability devices comprises setting the RRP ratio to 5% reduced capability devices and 95% non-reduced capability devices.

14. The system of claim 9, wherein the one or more reduced capability devices have a downlink limited to a maximum of 2 MIMO layers.

15. A method of improving spectral efficiency, the method comprising:
monitoring a service level of one or more reduced capability devices using a network slice;
determining that a spectral efficiency of the network slice has dropped below a spectral efficiency threshold; and
incrementally reducing a radio resource partitioning (RRP) ratio of the one or more reduced capability devices to non-reduced capability devices until the service level of the one or more reduced capability devices decreases to a service level threshold.

16. The method of claim 15, wherein an increment for decreasing the RRP ratio of the one or more reduced capability devices to non-reduced capability devices is by 5%.

17. The method of claim 15, wherein the service level threshold is 5 Mbps.

18. The method of claim 15, the method further comprising:
monitoring a usage level of the network slice; and
upon determining that the usage level of the network slice is above a saturation threshold and the service level of the one or more reduced capability devices is below the service level threshold, offloading one or more of the reduced capability devices to a second network slice.

19. The method of claim 15, wherein the one or more reduced capability devices have a downlink limited to a maximum of 2 MIMO layers.

20. The method of claim 15, wherein the one or more reduced capability devices have a maximum bandwidth of 20 MHz.
